(19) United States
(12) Patent Application Publication
(10) Pub. No.: US 2006/0243658 A1
(43) Pub. Date: Nov. 2, 2006

(54) Sorbent material having a covalently attached perfluorinated surface with functional groups

(76) Inventors: Vitali Pavlovich Zubov, MOSCOW (RU); Lutz Plobner, Erkrath (DE); Dimitri Valerjewich Kapoustine, Moskow (RU); Hamlet Balayan, Yerevan (AM); Makhmud Rakhmotovich Muydinov, Moskow (RU); Gottfried Brem, Hilgershausen (DE); Robert-Matthias Leiser, Solingen (DE)

Correspondence Address: JACOBSON HOLMAN PLLC, 400 SEVENTH STREET N.W., SUITE 600, WASHINGTON, DC, 20004, US

(21) Appl. No.: 10/534,031

(22) PCT Filed: Nov. 10, 2003
(86) PCT No.: PCT/EP03/12517

§ 371 Date: Jun. 12, 2006

Related U.S. Application Data
(60) Provisional application No. 60/475,785, filed on Jun. 5, 2003.

(30) Foreign Application Priority Data
Nov. 8, 2002 (EP) 02 024 885.2

(51) Int. Cl. B01D 39/00

(52) U.S. Cl. 210/502.1; 428/403; 428/407; 252/184

(57) ABSTRACT

The present invention relates to a sorbent material having a solid support substantially modified with a fluorinated polymer coating which is covalently attached to the support and the fluorinated polymer coating is containing at least one functional group, methods of obtaining the sorbent material, the use of these materials for separation of substances, a chromatographic column or cartridge at least partially filled with the sorbent material of the invention, a membrane-like device comprising the sorbent material of the invention, a device comprising the sorbent material of the invention in loose form as well as a miniaturized device comprising the sorbent material.

The present invention relates to a sorbent material having a solid support substantially modified with a fluorinated polymer coating which is covalently attached to the support and the fluorinated polymer coating is containing at least one functional group, methods of obtaining the sorbent material, the use of these materials for separation of substances, a chromatographic column or cartridge at least partially filled with the sorbent material of the invention, a membrane-like device comprising the sorbent material of the invention, a device comprising the sorbent material of the invention in loose form as well as a miniaturized device comprising the sorbent material.

The development of composite sorbent materials for stationary phases has led to substances with a wide range of chromatographic properties. These materials with modified surfaces are widely used in separation processes. Mostly, a hydrophilic support material, such as silica gel, is modified with hydrophobic moieties like alkyl chains of different length.

Many efforts have been made to improve the properties of the chromatographic material in terms of chemical stability, the field of applications or selectivity. Modification of the surface material moderates the properties of the stationary phases and influences the separation which is based on hydrophilic, hydrophobic or ion-ion interactions.

Fluorinated moieties, taking advantage of the higher polarity of the C—F bond over the C—H bond, give rise to a broadened spectrum of application s opportunities. It is known that perfluorinated polymers have, apart from their exceptional chemical stability, a unique range of sorption properties which allows to use them in separation processes of complex real or test mixtures of biopolymers, especially of nucleic acid or proteins, but the poor mechanical stability of these materials does not allow a direct use of perfluorinated polymers in chromatographic separation processes.

Efforts have been made to get composite fluorinated materials, in particular sorbents manufactured on the basis of solid porous silica gels. This is to combine in the same material the mechanical strength, determined by the porous nature of the inorganic matrix and the specific sorption properties of the fluorinated polymeric modifying compound.

EP 1 148 945 discloses such a material having a solid support of controlled pore glass and a coating of crosslinkable olefinic oligomers. Fluorination of the oligomer coated support is effected with gaseous xenon difluoride (XeF₂), optionally under inert gas conditions, or with a mixture of fluorine and an inert carrier gas. The composite material thus obtained is suitable for chromatographic separations. It is also used in the isolation of DNA out of complex mixtures, where apart of DNA also RNA, proteins, low molecular substances and salts are present. But, because of the exclusively hydrophobic nature of these materials, there are certain difficulties in using them with aqueous solutions of biopolymers and they are much more used for chromatographic separations in columns with increased pressure (HPLC) and operations using hydrophobic interaction chromatography (HIC).

Beside these applications, there is a growing need for applications which lead to the desired products in a fast and economic way, e.g. isolation and purification of DNA with effective removal of by-products and impurities. The fluorinated surface of the materials of EP 1 148 945 is, due to their essentially hydrophobic characteristics, not able to provide the capacity for the isolation of biopolymers without denaturating conditions, because of the lack of capability in wetting the fluorinated surface.

Another drawback of the composite materials according to EP 1 148 945 is, that fluorination with xenon difluoride or fluorine gas will not lead to a uniform surface of the coating and a perfectly fluorinated layer of the coating is hardly achieved.

The polymeric coating of the composites of EP 1 148 945 is manufactured via sorption of crosslinkable oligomeres on particles of the porous support. The missing chemical attachment of the coating does not correspond to the need of permanent availability of chemically stable stationary phases with exactly the same quality and the increasing demands of validated analysis protocols. Furthermore, the not desirable release of hydrogen fluoride during the production process is unavoidable.

Therefore, the object of the present invention is to provide a sorbent material with an advanced surface for biotechnological applications, such as isolation and separation of biopolymers, primarily in aqueous media, with improved access area of the separation surface in a separation medium and improved stability of the coating for the construction of material suitable for chromatographical applications like HPLC and fast sample preparations via solid phase extraction in compact cartridges for PCR-applications.

According to the invention, a sorbent material is provided having a solid support with a fluorinated polymer coating wherein the support is substantially modified with the fluorinated polymer coating which is covalently attached to this support and the fluorinated polymer coating is containing at least one functional group.

The functional groups exhibiting hydrophilic properties provide an essentially better wetting of the inner and outer surfaces of the pores of the sorbent material.

Preferably the support of the sorbent material of the invention is porous inorganic material selected from the group comprising inorganic metal oxides, such as oxides of aluminium, zirconium, silicon and/or iron. In particular preferred is porous glass which is used in the way of controlled pore glass (CPG). Typically, this shows pores in the range of 10 to 200 nm (medium pore size).

In another aspect of the invention, the support is an organic material, preferably of porous structure such as crosslinked polystyrenes, polyacrylates, and polyethylenes.

Preferably, the support containing inorganic or organic materials is in particle-like or monolithic membrane-like form and has a porous structure which shows a bidisperse or oligodisperse distribution of pore sizes, Such structures build, e.g., the basis for sorbent materials according to the present invention, which allow additionally to the separation of bio-macromolecules such as nucleic acids or proteins the improved retention of low molecular weight substances having, e.g., molecular weights of less than 500 Da. Such bidisperse supports may preferentially be obtained by means of gelling (gel building) of silica sols, starting the process with the mixture of two size types of monodisperse colloidal silica particles. The mass proportion of these two types of colloidal particles determines the proportion and distribution of differently sized pores in the final silica support material.

Typically, two types of silica sols are prestructured prior to mixing. Prestructuring occurs, e.g., by temperature treatment or other methods and partially evaporating water. The ratio of the mean diameter of the large pore size distribution and the lower pore size distribution is in the range of 3-15, in particular 4-10. The mean diameter of the larger pore size distribution should not be smaller than 25 to 50 nm and should not exceed 2000 nm, in another embodiment 1000 nm.

To create a uniform surface equally equipped with fluorine moieties, the support is modified with a perfluorinated or at least partially fluorinated polymer. This uniformity of the coating effectively increases the selectivity of binding of bio-macromolecules.

To enhance the chemical stability and durability of the sorbent material, the polymer coating is covalently attached to the support via Si—O—C, C—C, C—O—C and other chemical bonds, according to the chemical nature of the support material.

The polymer coating preferably has a thickness of about 10 to 250 Angström, preferably 10 to 100 Angström and micropores of less than 50 Å accessable to water, salts, and low molecular weight substances being non-adsorptive towards nucleic acids and adsorptive towards proteins.

The functional groups modifying the hydrophobic properties in contrast to a solely fluorinated surface are selected from the group consisting of hydroxy, amino, carboxyl, linear amides, cyclic amides, bromide, and aldehyde.

The low chemical reactivity of fluorinated compounds hampers the manufacturing of composite materials according to the invention. These difficulties are circumvented by placing the support material in a reaction vessel with connection to a vacuum pump. At lower temperature and/or lower pressure compared to ambient conditions fluorine containing olefinic monomer(s), preferably tetrafluoroethylene and hexafluoropropylene, are deposited in the reaction vessel. The support material is irradiated using high energy radiation to create reactive surface radicals. The following reaction is influenced by subsequent introduction of at least one second monomer having at least one olefinic moiety and at least one additional function group. With controlled addition of monomers bearing at least one hydrophilic functional group to the gas phase of the reaction vessel at a predetermined stage of the irradiation the heterogenic phase co-polymerisation is performed and the hydrophilic functional groups of choice are introduced.

This leads to an increase of hydrophilicity at the perfluorinated surfaces with maintenance of specific sorption properties and the capability of hydrophobic, hydrophilic and ion-ion interactions for the separation of biopolymers is provided. The surface radicals of the support will be obtained by the way of X-ray, gamma, UV or ozone treatment.

Another advantage of the introduction of reactive functional groups is the opportunity of further chemical modification of the surface and with that the optimisation of selectivity of the materials of the invention.

In another embodiment of the invention, a mixture of olefinic fluorine containing monomer(s), preferably tetrafluoroethylene and/or hexafluoropropylene, and at least one second monomer containing at least one olefinic moiety and at least one additional functional group are placed in a solution of a keton, preferably aceton, or an alcohol, preferably 2-propanol in a closed reaction vessel. The solution is irradiated with high energy radiation to initiate the reaction of the solvent, the fluorine containing monomer(s) and other monomer(s) containing at least one functional group.

After co-telomerisation the deposition of the reaction product of keton and/or alcohol and the mixture of fluorine containing monomer(s) and other monomer(s) containing at least one olefinic moiety and at least one additional functional group is effected with a subsequent temperature increase, thermically or via microwave-irradiation.

The second monomer(s) containing at least one functional group are preferably selected from the group consisting of vinyl acetate, allyl alcohol, allyl bromide, (meth)acrylic acid, vinylacetic acid, N-vinyl pyrrolidone, (di)alkylamine, acrolein, and hydroxyethyl(meth)acrylate.

The sorbent material according to the invention is useful in separation processes, enhancing the ease of handling and the speed of these processes. Preferably, the substances to be separated are nucleic acids and/or proteins. A conventionally used chromatographic column or cartridge can be filled, at least partially, with the sorbent material of the invention. The sorbent material of the invention behaves similar to other solid chromatographic supports so that the methods for filling chromatographic columns or cartridges can be used in an analogous manner. The support for carrying out chromatographic separations can also be provided in the form of a membrane-like item comprising the sorbent material of the invention, wherein the sorbent material is embedded in a polymeric matrix such as a nylon membrane. Also other membrane materials which are used in preparation, isolation or separation of biomolecules can be used as matrix for embedding a sorbent material of the present invention.

In order to ease the use of a chromatographic material of the invention it is advantageous to provide the sorbent material according to the invention in a loose form or a chromatographic column-or cartridge or membrane-like device together with filter materials, reagents and/or buffers or other devices or chemicals for performing sample preparation and chromatographic separations. This item, can especially be provided in form of a kit or a miniaturized device in form of chips or microreactors. The chromatographic separation is not limited in its scale. It can be used in any chromatographic operation for separation, isolation, identification, purification and/or detection of biomolecules, in particular nucleic acids, in preparative or analytical scale.

The present invention provides a product with advanced sorption properties that allows to use this product for chromatography of biomacromolecules according to the object of the invention. The perfluorinated support material shows a uniform coating, which is attached by covalent bonds at the surface of the support material. The sorbent material shows substantially improved storage properties comparing to the material described in EP 1 148 945. This is illustrated in the following Table, which reflects comparative analyses of three lots of each sorbent type in respect to their usage for DNA purification following the Protocol for lysis and isolation of genomic DNA from Bacteria, which is described in the Example part (s. below).

| Sorbent type | Storage at | stability |
|---|---|---|
| Material according to EP 1 148 945 | 25° C. | 1 week |
| Material according to the present | 25° C. | 3 months |
| invention | | |

The invention is further explained in the following examples which are understood to be not limiting.

### EXAMPLE 1

10 g of GPB-Trisopor-500 (effective pore diameter 50 nm) are placed into the glass ampoule and connected with the vacuum plant. The ampoule is evacuated to a pressure of about 13-14 mBar during the heating using a sand bath to 573 K. After that 1 g of tetrafluoroethylene was frozen into the ampoule. The ampoule was disconnected from the plant and it was heated to room temperature and incubated at room temperature for 2 h. Then the ampoule was cooled to 77 K with a rate of about 0.1 K/sec and it was irradiated using a γ-source with a dose of about 5 Mrad. After that the ampoule was heated to room temperature and incubated for 3 h, it was connected to the vacuum plant for further evacuation to a pressure of about 10⁻³ mBar. After that the acrolein vapors (0.1 g, P=270 mBar) were added into the system (the monomer consumption was observed by the pressure decreasing). The plenty of the monomer was frozen into the reserve vessel. After that the ampoule was disconnected from the plant.

### EXAMPLE 2

The synthesis of the sorbent was carried out as in Example 1, but the freezing process was with a cooling rate of about 0.3 K/sec and an irradiation dose of about 6 Mrad.

### EXAMPLE 3

The synthesis of the sorbent was carried out as in Example 1, but 2-hydroxyethylmetacrylate was used as a monomer (0.2 g, P=333 mBar).

### EXAMPLE 4

The synthesis of the sorbent was carried out as in Example 1, but diallylamine was used as a monomer (0.05 g, P=200 mBar).

### EXAMPLE 5

The synthesis of the sorbent was carried out as in Example 1, but allylbromide was used as a monomer (0.2 g, P=333 mBar).

### EXAMPLE 6

The solution of the mixture containing the monomers was prepared as follows: 900 ml of dry acetone placed into the glass or iron vessel was frozen and was degassed repeatedly to remove the air. After that the mixture containing the tetrafluoroethylene (5.3% from the weight of acetone) and vapors of another monomer (0.33% from the weight of acetone) were added into the same vessel (to a pressure of about 1.6 Bar) and were frozen. After that the vessel was closed hermetically and the temperature was increased to 20° C. The vessel containing the monomers with acetone was irradiated by a γ-source (⁶⁰Co) for 2 h with a dose of about 5 Hr/h. After the irradiation the reactor was opened and unreacted monomer was removed. IR-spectroscopy data were obtained indicating the presence of the acetone fragments in the content of the cotelomere.

### EXAMPLE 7

The solution of the cotelomers was prepared as in Example 6, but hexafluoropropylene was used as a monomer.

### EXAMPLE 8

The solution of the cotelomers was prepared as in Example 6, but allylbromide is was used as a monomer.

### EXAMPLE 9

The solution of the cotelomers was prepared as in Example 6, but N-vinyl-caprolactam was used as a monomer.

### EXAMPLE 10

The solution of the cotelomers was prepared as in Example 6, but N-vinyl-pyrrolidone was used as a monomer.

### EXAMPLE 11

The solution of the cotelomers was prepared as in Example 6, but 2-hydroxyethylmethacrylate was used as a monomer.

### EXAMPLE 12

The solution of the cotelomers was prepared as in Example 6, but 2-propanol was used as a telogen and hexafluoropropylene was used as a monomer.

### EXAMPLE 13

The solution of the cotelomers were prepared as in Examples 7 and 12. After the preparing the solution were mixed with the proportion 9:1.

### EXAMPLE 14

3 g support material, e.g. GPB Trisopor-500 (effective pore diameter 50 nm and effective surface 112 m²/g) are placed in a glass ampoule connected with the vacuum pump. The ampoule with the support is evacuated to a pressure of 10 mBar within 30 min. After that the valve to the pump is closed and another valve, connected to a reservoir is opened, this containing 40 ml of the telomer liquid tetrafluoroethylene in acetone in a concentration of 0.36% (w/v). The solution is piped to the ground of the reaction vessel, the reactor is filled and the solution is added to the pores of the support. Then the reactor is brought to atmospheric pressure.

In the following the vessel is treated 15 min with ultrasound for uniform distribution of the telomer solution within the pores of the support. Then the vessel is connected with a rotary evaporator and excess solvent (acetone) is evacuated via water jet pump (16 mm Hg) and a steam bath. Evacuation of acetone in the vacuum rotary evaporator is continued for 3 h via oil pump. Finally, the sorbent is brought into a drying cabinet and dried for 3 h at 200° C.

The thus obtained sorbent material is powdery, hardly wettable with water, white and odourless.

### EXAMPLE 15

Coating of the support surface is carried out as in Example 14, but 6 g support GPB Trisopor-500 and 40 ml 0.12% (w/v) tetrafluoroethylene in acetone is used. After obtaining the dried powdery sorbent the vessel is evacuated and a new 40 ml telomer portion is added. This procedure is repeated once again and all stages of the drying process are performed as in Example 14.

### EXAMPLE 16

The synthesis of the sorbent is; carried out as in Example 15, but the support is treated only twice with 40 ml 0.18% (w/v) telomer solution.

### EXAMPLE 17

The synthesis of the sorbent is carried out as in Example 14, but MPS-1150 GCh is used as support material (effective pore diameter 100 nm, effective surface 33 m²) and treated with 40 ml telomer solution tetrafluoroethylene 0.106% (w/v).

### EXAMPLE 18

The sorbent is obtained as described in Example 15 with the support material of Example 17. Treatment with 40 ml telomer solution 0.053% (w/v) takes place twice.

### EXAMPLE 19

The sorbent is obtained as described in Example 18 with threefold treatment with 40 ml telomer solution 0.032% (w/v).

### EXAMPLE 20

The sorbent was prepared as in Example 19, but the carrier was treated by the cotelomer solution as obtained in Example 7.

### EXAMPLE 21

The sorbent was prepared as in Example 19, but the carrier was treated by the cotelomer solution as obtained in Example 8.

### EXAMPLE 22

The sorbent was prepared as in Example 19, but the carrier was treated by the cotelomer solution as obtained in Example 9.

### EXAMPLE 23

The sorbent was prepared as in Example 19, but the carrier was treated by the cotelomer solution as obtained in Example 10.

### EXAMPLE 24

The sorbent was prepared as in Example 19, but the carrier was treated by the cotelomer solution as obtained in Example 11.

### EXAMPLE 25

The sorbent was prepared as in Example 19, but the carrier was treated by the cotelomer solution as obtained in Example 12.

### EXAMPLE 26

The sorbent was prepared as in Example 19, but the carrier was treated by the cotelomer solution as obtained in Example 13.

### EXAMPLE 27

For the synthesis of sorbents described in examples 1-26, a silica gel support with controlled bidisperse pore structures has been prepared in the following way:

The two starting types of silica sol in water had following characteristics:

A: particle diameter: 6 nm; SiO₂ concentration: 22 mass %; Na⁺-stabilised pH: 9.1

B: particle diameter: 40 nm; SiO₂ concentration: 40 mass %; Na⁺-stabilised pH: 9.2

Water from the two silica sols was evaporated at pH 5.0 in a water bath at 80° C. by constant stirring until 30 and 60 mass %, respectively. To 100 ml of sol A structured by evaporation were added 50 ml of structured sol B and the evaporation has been continued until the formation of a homogeneous gel. The silica hydrogel obtained after 4 hours sinerethis (partial shrinkage) was dried, first for 4 hours at 80° C. in a water bath, followed by 3 hours at 130° C. in a drying hood. Afterwards the product was treated at 600° C. for 5 hours in a muffel oven. The ready obtained silica gel was grinded, fractionated and analysed for pore size distribution both by mercury porometry (according to DIN 66 133 (1993)) and BET-method (according to ISO 9277). These analyses showed a preferential pore size in two classes of 5 nm and 28 nm, a sorption volume of 0.7 cm³/gr and a specific surface of 120 m²/gr.

### EXAMPLE 28

The two starting types of silica sol in water had following characteristics:

A: particle diameter: 10 nm; SiO₂ concentration: 30 mass %; Na⁺-stabilised pH: 9.2

B. particle diameter: 80 nm; SiO₂ concentration: 50 mass 0/0; Na⁺-stabilised pH: 9.1

The silica gel sorbent was prepared as in example 27, with following variations:

Water from the two silica sols was evaporated at pH 4.5 in a water bath at 80° C. by constant stirring until 52 and 60 mass %, respectively. To 100 ml of sol A structured by evaporation were added 130 ml of structured sol B. Analyses showed a preferential pore size in two classes of 7 nm and 60 nm, a sorption volume of 0.75 cm³/gr and a specific surface of 95 m²/gr.

### EXAMPLE 29

Testing of the Sorbents

A. Mercury Porometry

The porogrammes obtained by testing the sorbents based on the macroporous glasses GPB-Trisopor 500 and MPS 1150 GCh show the distribution of the pores in differential and integral manner and allow to determine the medium pore size of the sorbent as well as the effective thickness of the polymeric layer, which is 5-7.5 nm.

B. Determination of Hydrolytic Stability

Samples of the sorbent based on macroporous glasses GPB-Trisopor 500 and MPS 115.0 GCh and the samples of unmodified supports were incubated under basic conditions (Tris-buffer, pH 10.5) for 32 h. Aliquots of the supernatant were taken at predetermined times of incubation and mixed with a 0.5 M solution of ammonium molybdate and sulphuric acid ( 1/200 of volume of aliquot). The adsorption of silicon molybdate indicates the release of silicates from the surface of the support and the interaction with ammonium molybdate. The smallest peak was found by incubation of the sorbents obtained according to Examples 14 and 19. The hydrolytic stability of the modified sorbents was increased to the 2.8- to 23-fold.

### EXAMPLE 30

The sorbents were prepared as in Example 19. The sorbent samples (0.1 g of each ones) were incubated in 5 ml in a mixture of equal volumes of methanol and 0.01 M Tris aqueous solution (pH 11.0) under slow mixing at room temperature for 16 h. The aliquots (1 ml) of the supernatant from each sample were collected every hour. The equal volumes of the 0.05 M sodium molybdate aqueous solution in the presence of sulfuric acid were added to each supernatant. After that the aliquots (1 ml) of 0.1 M sulfosalicylic acid aqueous solution were added to each sample and the samples were tested by UV-spectroscopy. The data obtained show that the sorbents were characterized by the higher hydrolytic stability in comparison with the unmodified carrier, especially during the first hours of the process. That confirmed the obtaining of the stable composite sorbents with the solid unbroken polymer layer immobilized on the surface of the carrier.

### EXAMPLE 31

The sorbents were prepared as in Example 19. The tests for hydrolytic stability were carried out as in the Example 14, but the sorbent samples were incubated in 5 ml of 0.01 M Tris. The results obtained show that prepared sorbents are also characterized by the high hydrolytic stability.

### EXAMPLE 32

The sample of obtained sorbents (as in Examples 14-26) were incubated in acetone at room temperature at slow mixing for 16 h. The aliquots were collected from each sample every hour. The aliquots were tested by UV-spectroscopy. The data obtained confirm the only insignificant increasing of the monomer content in the tested solutions even after 6 h of the incubation. That confirmed the presence of covalently bonded polymer phase on the surface of the carrier.

### EXAMPLE 33

The cotelomer solutions were prepared as in Examples 8, 9 and 11. The aliquots (100 ml) were collected from the tested solutions and the thin films were formed on the surface of the NaBr glass after removing the solution. The obtained immobilized films were studied by IR-spectroscopy. After that the studied films were thermosetted at 200° C. for 3 h. The thermosetted films were also studied by IR-spectroscopy. The obtained data show that the bands at 2960-2950, about 1400, 1300 and about 1200 cm⁻¹ were constantly observed for all of the tested films. Those bands are corresponding to the IR-spectrum of the pure tetrafluoroethylene, At that the band about 1700 cm⁻ was significantly decreased after the thermosetting that indicates the removal of telogen moieties during the heating of the film. This process is accompanied by chemical bond formation between the carrier surface and the polymer phase. The residual band at 1700 cm⁻¹ was observed for the sample solution obtained as in Example 11. It can be explained as a result of a chemical binding of 2-hydroxyethyl-methacrylate monomer during the copolymerization process. For the samples of examples 8 and 9 the additional bands at 2330 cm⁻¹ (with using of N-vinylcaprolactam as a comonomer) as well as about 3000 and 1600 cm⁻¹ (using allylbromide as a comonomer) were observed as a result of a chemical binding of the corresponding comonomers.

Protocol for Tissue Lysis and Extraction of Genomic DNA from Tissue Samples (e.g. TyPifix)

The kit contains all necessary reagents for lysis of cells or tissue and genomic DNA purification. The resulting DNA is suitable for most enzymatic reactions (restriction digests, PCR, sequencing etc.).

Compared to most other protocols not DNA is retained by the column resin, but proteins, detergents and low molecular weight compounds are. DNA flows through the column during a short, one-step purification procedure.

Storage Conditions:

All kit components are stable at room temperature during shipment. After arrival store the kit at +2° C. to +8° C. Columns may be stored at room temperature.

Materials:

| | |
|---|---|
| Buffer G1 | 10 vials (blue), each for 5 isolations |
| Buffer G2 | 10 vials (blue), each for 5 isolations |
| Nexttec clean-columns | 50 columns |

Materials not Provided:

Eppendorf tubes (1.5 ml)

Tris-HCl, 50 mM, pH 8

Preparation of Buffers
1. Immediately before use add 1.6 ml of deionized water to a tube with lyophilised buffer G1. Dissolve the constituents by vortexing the tube.
2. Shortly centrifuge a tube containing buffer G2 to collect the components at the bottom of the tube.
3. Transfer the solution of buffer G1 completely to one aliquot (tube) of buffer G2
4. Mix the buffers to get a homogeneous solution.
5. The mixture contains all components necessary for tissue or cell lysis and is now ready for use. The mixture is sufficient for 5 isolations. (The mixture should be used immediately. Therefore, prepare only as much buffer as needed for the number of samples to be analysed.)

Cell or Tissue Lysis
1. transfer cells or a tissue sample into an Eppendorf tube (<15 mg fresh weight)
2. add 300 μl of lysis buffer mixture (see preparation of buffers) to each cell or tissue sample
3. incubate the samples at 60° C. overnight with constant shaking at ˜800 rpm in an Eppendorf thermomixer (Typifix samples are dry. If fresh tissue is used, shorter incubation periods may be sufficient for complete lysis.)
4. clear the lysate by centrifugation for 3 min at 20,000×g
5. Take 120 μl from the clear supernatant for DNA purification. The remaining lysate can be stored at −20° C.

Purification of DNA
6. open the spin-columns, add 300 μl Tris-HCl buffer (50 mM, pH 8.0) onto each column and close the lids several times to “pump” the buffer into the sorbent layer
7. centrifuge the columns at 400×g (corresponds to approx. 2,000 rpm in a 24-place Eppendorf rotor of a microfuge) for 1 min to remove excess of buffer
8. discard the collection tubes with the buffer, place the columns into a new Eppendorf tube and open the columns
9. transfer 120 μl of the cleared supernatant from step 4 onto the columns and close the lids (the lysate enters the resin layer)
10. incubate the columns for 3 min at room temperature
11. spin the tubes with the columns at 800×g (corresponds to approx. 3,000 rpm in a 24-place Eppendorf rotor of a microfuge) for 1 min
12. The flow-through contains the purified DNA. Discard the columns and use the DNA immediately or store it at −20° C.

Protocol for Lysis and Isolation of Genomic DNA from Bacteria

The kit contains all necessary reagents for lysis of bacterial cells and DNA purification. It is approved for many Gram(−) as well as Gram(+) bacteria. The resulting DNA is suitable for most enzymatic reactions (restriction digests, PCR, sequencing etc.).

Compared to most other protocols not DNA is retained by the column resin, but proteins, detergents and low molecular weight compounds are. DNA flows through the column during a short, one-step purification procedure.

Storage Conditions:

All kit components are stable at room temperature during shipment. After arrival store RNase solution at −20° C. The other kit components must be stored at +2° C. to +8° C. Nexttec clean-columns may be stored at room temperature.

Materials Provided:

| | |
|---|---|
| Buffer B1 (basis buffer) | 5 vials (white), each for 10 isolations |
| Buffer B2 | 5 vials (white), each for 10 isolations |
| Buffer B3 | 5 vials (white), each for 10 isolations |
| Nexttec clean-columns | 50 columns |
| RNase solution | 1 vial (white), for 50 isolations |

Materials not Provided:

Lysozyme

Eppendorf tubes (1.5 ml)

Tris-HCl, 50 mM, pH 8

Preparation of Suffers
6. Prepare a 20 mg/ml lysozyme solution in pure water (use lyophilized lysozyme for example from Sigma Kat.-Nr. L-6876 or comparable). The dissolved lysozyme should be stored frozen at −20° C.
7. Each vial with buffer B1 (basis buffer) is sufficient for 10 DNA preparations. Immediately before use complete the buffer by adding 110 μl lysozyme stock solution (20 mg/ml) and 220 μl RNase solution. Mix by vortexing the tube.
8. Shortly centrifuge a vial containing buffer B2 to collect the components at the bottom of the tube, then add 550 μl deionized water and vortex. The prepared buffer B2 can be stored for 2 days at +4° C.
9. Add 550 μl deionized water to one vial with buffer B3 and dissolve the constituents by vortexing. The resuspended buffer should be used immediately.

Lysis of Bacterial Cells:
1. grow an overnight culture of bacteria in a suitable medium (e.g. LB, CSB)
2. transfer 0.5 ml of the culture to 1.5 ml Eppendorf tubes (1.5 OD₆₀₀)
3. pellet the cells by centrifugation at 6,000×g for 1 min, remove and discard is the supernatant
4. add 120 μl buffer B1 (containing lysozyme and RNase solution) to the bacterial cell pellet
5. gently vortex the tube to resuspend the cells
6. incubate the tube for 30 min at 37° C. constantly shaking (1,200 rpm, Eppendorf thermomixer)
7. add 50 μl of buffer B2 and incubate for 5 min at 60° C. (1,200 rpm, Eppendorf thermomixer)
8. then add 50 μl of buffer B3 and continue the incubation at 60° C. for 25 min (as described in step 7) in the thermomixer
9. In most cases the lysate should be clear after the incubation. If it is not, centrifuge the tube for 3 min at 20,000×g to pellet cell debris.

Purification of DNA
10. open the spin-columns, add 300 μl Tris-HCl buffer (50 mM, pH 8.0) onto the column and close the lid several times to “pump” the buffer into the sorbent layer
11. centrifuge the columns at 400×g (corresponds to approx. 2,000 rpm in a 24-place Eppendorf rotor of a microfuge) for 1 min to remove excess of buffer
12. discard the collection tubes with the buffer, place the columns into new Eppendorf tubes and open the columns
13. transfer 120 μl of the clear lysate from step 9 onto the columns and close the lid (the lysate enters the sorbent layer)
14. incubate the columns for 3 min at room temperature
15. centrifuge the tubes with the columns at 800×g (corresponds to approx. 3,000 rpm in a 24-place Eppendorf rotor of a microfuge) for 1 min
16. The flow-through contains the purified DNA. Discard the columns and use the DNA immediately or store it at −20° C.

1. Sorbent material having a solid support modified with a fluorinated polymer coating characterized in that the support is substantially modified with the fluorinated polymer coating which is covalently attached to the support and the fluorinated polymer coating is containing at least one functional group.

2. The sorbent material according to claim 1 wherein the support is a porous inorganic material selected from the group comprising inorganic metal oxides, such as oxides of aluminium, titanium, zirconium, silicon oxides, and/or iron oxides.

3. The sorbent material according to claim 1 wherein the support is an organic material, preferably of porous structure such as cross-linked polystyrenes, polyacrylates, and polyethylenes.

4. The sorbent material according to claim 1, wherein the organic/inorganic materials having a porous structure show at least a bidisperse distribution of the pore sizes.

5. The sorbent material according to claim 4, wherein the inorganic material with a bidisperse distribution of the pore sizes is obtainable by gelling a mixture of two silica sols having differently sized colloidal silica particles.

6. The sorbent material according to claim 2 wherein the support is in particle-like or monolithic membrane-like form.

7. The sorbent material according to claim 1 wherein the support is modified with a perfluorinated or at least partially fluorinated polymer.

8. The sorbent material according to claim 1 wherein the polymer coating is covalently attached to the support via Si—O—C, C—C, C—O—C and other chemical bonds, according to the chemical nature of the support material.

9. Sorbent material according to claim 1, wherein the surface functional groups are selected from the group consisting of hydroxy, amino, carboxyl, linear amides, cyclic amides, bromide, and aldehyde.

10. Sorbent material according to claim 1, wherein the polymer coating has a thickness of preferably 10 to 250 Å.

11. Sorbent material according to claim 1, wherein the polymer coating has a uniform thickness of preferably 10 to 100 Å and micropores of less than 50 Å accessable to water, salts, and low molecular weight substances being non-adsorptive towards nucleic acids and adsorptive towards proteins.

12. Method of obtaining a sorbent material according to claim 1, characterized in depositing at lower temperature and/or pressure compared to ambient conditions fluorine containing monomer(s) on the support having surface radicals, and subsequent introduction of at least one second monomer having at least one olefinic moiety and at least one additional functional group.

13. Method of obtaining a sorbent material according to claim 12, characterized in deposition of a reaction product of ketone and/or alcohol and a mixture of fluorine containing monomer(s) and at least one second monomer containing at least one olefinic moiety and at least one additional functional group with a subsequent temperature increase.

14. Method according to claim 12, wherein the second monomer(s) are preferably vinylacetate, allylalcohol, allylbromide, (meth)acrylic acid, vinylacetic acid, N-vinylpyrrolidone, (di)alkylamine, acrolein, and hydroxyethyl(meth)acrylate.

15. Method according to claim 12, wherein the surface radicals of the support will be obtained by high energy radiation such as X-ray, gamma, UV or by ozone treatment.

16. Method for separation of substances using the sorbent material according to claim 1 in a separation process.

17. Method for separation of substances according to claim 16, wherein the substances are nucleic acids and/or proteins.

18. A chromatographic column or cartridge filled at least partially with the sorbent material according to claim 1.

19. Method for separation of substances according to claim 16, wherein nucleic acids flow through a chromatographic column or cartridge according to claim 18 without retention while proteins, salts and other low molecular weight substances are retained.

20. A membrane-like device comprising the sorbent material according to claim 1, which is embedded in a polymeric matrix, such as a nylon membrane.

21. A device comprising the sorbent material of claim 1 in loose form preferably for batch or magnetic separation.

22. A miniaturized device comprising the sorbent material of claim 1 for detection and/or separation of bioorganic compounds.

23. Miniaturized device according to claim 21 in form of chips or microreactors.
